(19) United States
(12) Patent Application Publication
(10) Pub. No.: US 2009/0228582 A1
(43) Pub. Date: Sep. 10, 2009

(54) SYSTEM AND METHOD IN A COMMUNICATION SYSTEM WITH CONCEALED SOURCES

(75) Inventors: SCOTT WHITE, Austin, TX (US); JAMES L. CANSLER, Pflugerville, TX (US); IAN C. SCHMEHL, San Antonio, TX (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/043,778

(22) Filed: Mar. 6, 2008

(51) Int. Cl. G06F 15/16

(52) U.S. Cl. 709/224; 709/223; 709/225

(57) ABSTRACT

A system that incorporates teachings of the present disclosure may include, for example, a proxy system having a controller to submit to law enforcement agency an identity of a source that conceals its identity with one or more anonymous Internet Protocol addresses. Other embodiments are disclosed.

### FIELD OF THE DISCLOSURE

The present disclosure relates generally to communications systems utilizing concealment techniques and more specifically to a system and method in a communication system with concealed sources.

### BACKGROUND

Typically a domain name system (DNS) operating in an Internet Service Provider (ISP) network assigns customer premise equipment (CPE) such as a broadband Internet modem an Internet Protocol (IP) address to facilitate communications with third party devices over the Internet. When communicating with third party devices such as a third party web server, the IP address assigned to the CPE can be easily detected by the web server utilizing known software techniques.

Cyber criminals can utilize the IP address to conduct criminal activity such as stealing personal information associated with a user of the CPE and/or tracking online activities of the user. To prevent cyber criminals from identifying the CPE, some service providers offer a proxy service to conceal the IP address assigned to the CPE thereby concealing the CPE and equipment coupled thereto.

### BRIEF DESCRIPTION OF THE DRAWINGS

FIGS. 1-4 depict exemplary embodiments of communication systems that provide media services;

FIG. 5 depicts an exemplary embodiment of a portal interacting with at least one among the communication systems of FIGS. 1-4;

FIG. 6 depicts an exemplary method operating in portions of the communication systems of FIGS. 1-4;

FIG. 7 depicts an exemplary block diagram for describing the method of FIG. 6; and

FIG. 8 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a method involving receiving from a law enforcement agency (LEA) an anonymous Internet Protocol (IP) address accompanied with a time stamp, determining from the anonymous IP address and the time stamp at least one of an identity of the anonymous source and an IP address of customer premise equipment (CPE) used by the anonymous source to engage in Internet activities, and submitting to the LEA at least one of the identity of the anonymous source and the IP address of the CPE used by the anonymous source.

Another embodiment of the present disclosure entails a computer-readable storage medium having computer instructions for determining from an anonymous IP address and a time stamp supplied by an LEA at least one of an identity of an anonymous source and an IP address of a CPE used by the anonymous source to engage in concealed Internet activities.

Yet another embodiment of the present disclosure entails a proxy system having a controller to submit to an LEA an identity of a source that conceals its identity with one or more anonymous IP addresses.

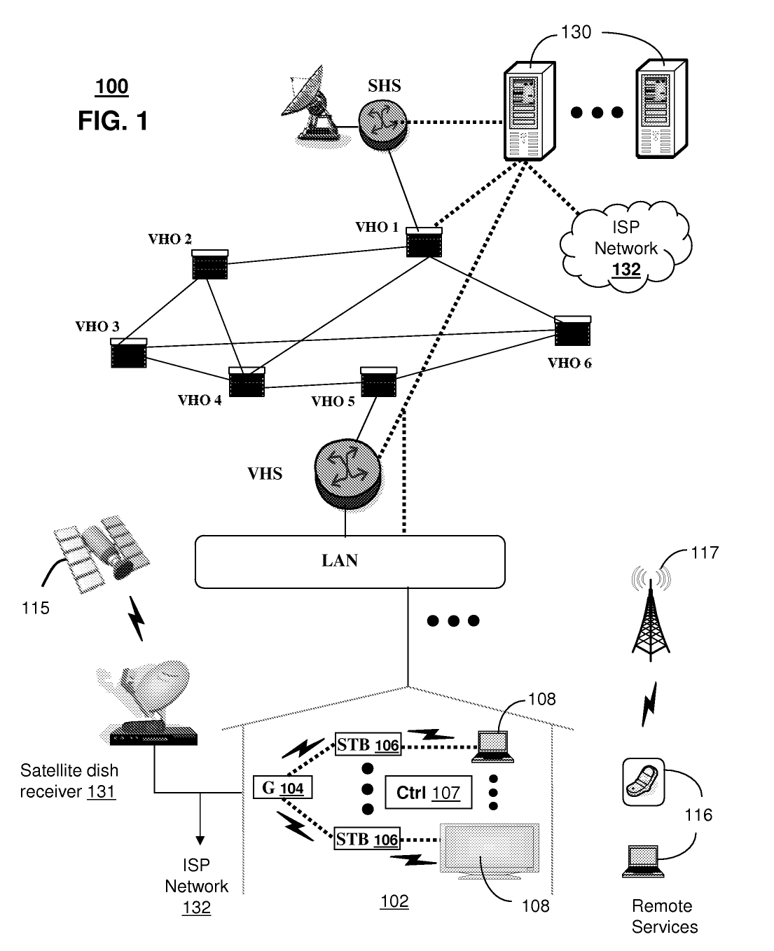

FIG. 1 depicts an exemplary embodiment of a first communication system 100 for delivering media content. The communication system 100 can represent an Internet Protocol Television (IPTV) broadcast media system. In a typical IPTV infrastructure, there is at least one super head-end office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as Set-Top Boxes (STBs) which in turn present broadcast selections to media devices 108 such as computers or television sets managed in some instances by a media controller 107 (e.g., an infrared or RF remote control). Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and present multicast or unicast media content.

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.). Another distinct portion of the one or more computing devices 130 can be used as a proxy system 130 for generating anonymous Internet Protocol (IP) addresses to conceal the identity of consumer premise equipment accessing public sites on the Internet. Consumer premise equipment can represent for example the STB 106 and/or a fixed line or portable computer or cell phone such as references 108 and 116 coupled to the ISP network 132 depicted in the media communication system 100 of FIG. 1.

A satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems such as cable TV systems.

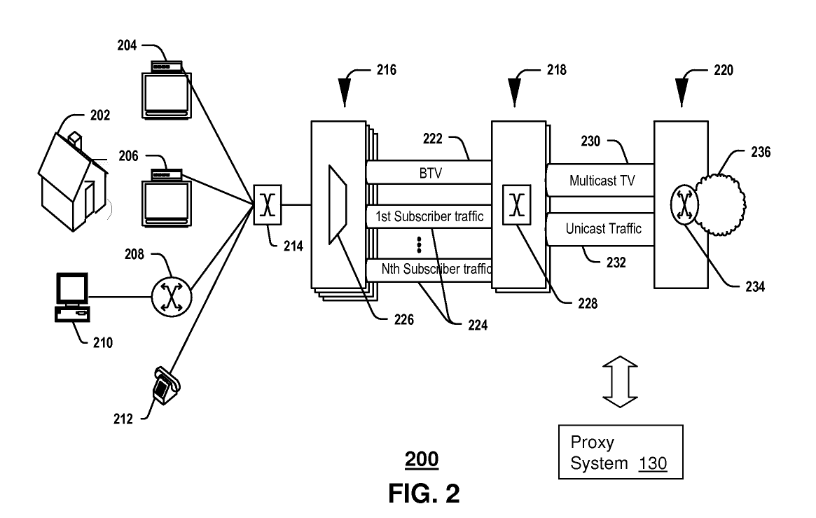

FIG. 2 depicts an exemplary embodiment of a second communication system 200 for delivering media content. Communication system 200 can be overlaid or operably coupled with communication system 100 as another representative embodiment of said communication system. The system 200 includes a distribution switch/router system 228 at a central office 218. The distribution switch/router system 228 receives video data via a multicast television stream 230 from a second distribution switch/router 234 at an intermediate office 220. The multicast television stream 230 includes Internet Protocol (IP) data packets addressed to a multicast IP address associated with a television channel. The distribution switch/router system 228 can cache data associated with each television channel received from the intermediate office 220.

The distribution switch/router system 228 also receives unicast data traffic from the intermediate office 220 via a unicast traffic stream 232. The unicast traffic stream 232 includes data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, receives a channel change command from an input device, such as a remoter control device. The channel change command can indicate selection of an IPTV channel. After receiving the channel change command, the set-top box device 204 generates channel selection data that indicates the selection of the IPTV channel. The set-top box device 204 can send the channel selection data to the access switch/router system 226 via the residential gateway 214. The channel selection data can include an Internet Group Management Protocol (IGMP) Join request. In an illustrative embodiment, the access switch/router system 226 can identify whether it is joined to a multicast group associated with the requested channel based on information in the IGMP Join request.

If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

The proxy system 130 of FIG. 1 can be operably coupled to the second communication system 200 for purposes similar to those described above.

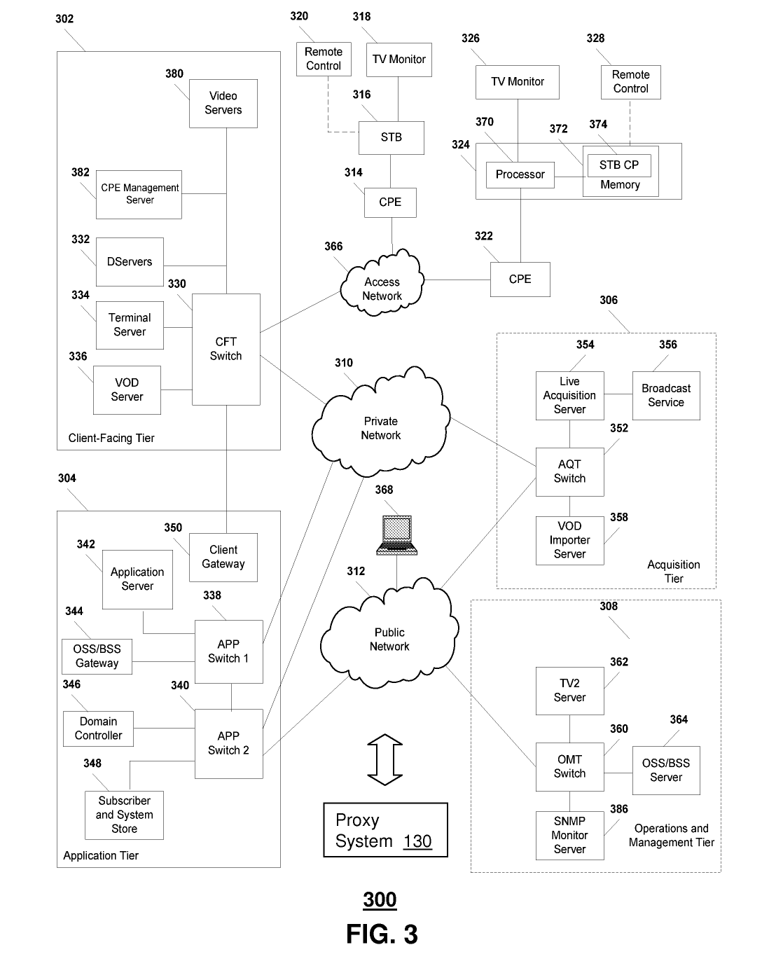

FIG. 3 depicts an exemplary embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 is coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 322.

As illustrated in FIG. 3, the various tiers 302, 304, 306, 308 communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an exemplary embodiment, the client-facing tier 302 can be coupled to the CPE 314, 322 via fiber optic cables. In another exemplary embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a video-on-demand (VOD) server 336 that stores or provides VOD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VOD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VOD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VOD server 336 at the client-facing tier 302 via the private network 310. Additionally, at the acquisition tier 306, the video-on-demand (VOD) importer server 358 can receive content from one or more VOD sources outside the IPTV system 300, such as movie studios and programmers of non-live content. The VOD importer server 358 can transmit the VOD content to the AQT switch 352, and the AQT switch 352, in turn, can communicate the material to the CFT switch 330 via the private network 310. The VOD content can be stored at one or more servers, such as the VOD server 336.

When users issue requests for VOD content via the set-top box devices 316, 324, the requests can be transmitted over the access network 366 to the VOD server 336, via the CFT switch 330. Upon receiving such requests, the VOD server 336 can retrieve the requested VOD content and transmit the content to the set-top box devices 316, 324 across the access network 366, via the CFT switch 330. The set-top box devices 316, 324 can transmit the VOD content to the television monitors 318, 326. In an illustrative embodiment, video or audio portions of VOD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

The proxy system 130 of FIGS. 1-2 can be operably coupled to the third communication system 300 for purposes similar to those described above.

It should be apparent to one of ordinary skill in the art from the foregoing media communication system embodiments that other suitable media communication systems for distributing broadcast media content as well as peer-to-peer exchange of content can be applied to the present disclosure.

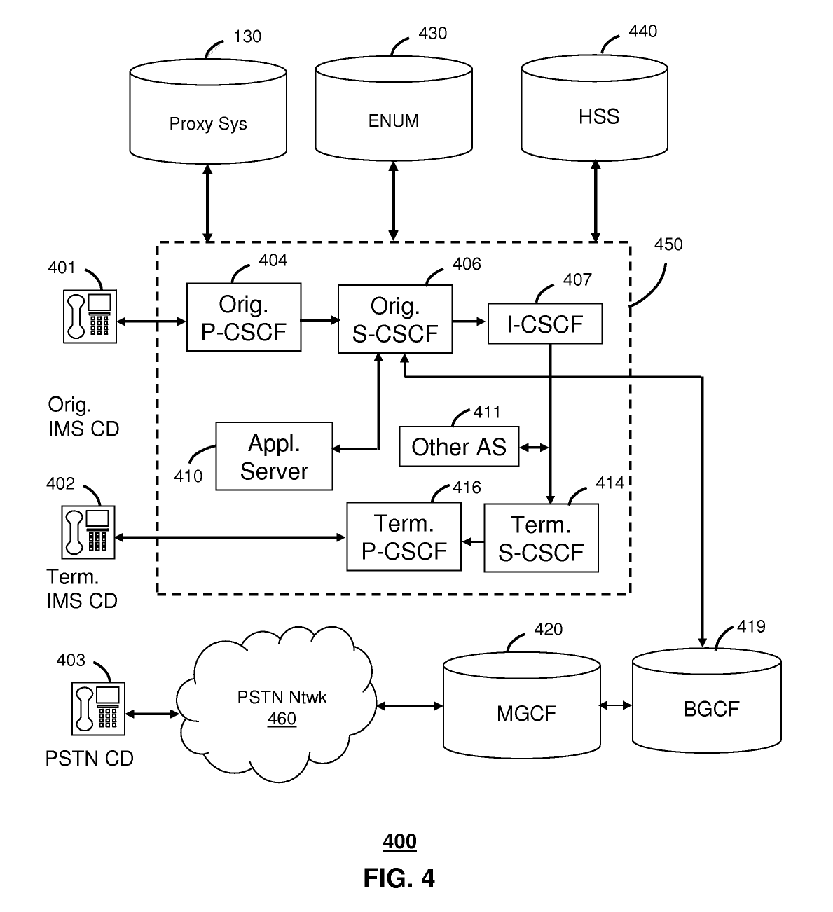

FIG. 4 depicts an exemplary embodiment of a communication system 400 employing a IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) support by the HSS 440. To accomplish a communication session between CDs, an originating IMS CD 401 can submit a SIP INVITE message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E. 164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (BGCF) 419.

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process is symmetrical. Accordingly, the terms “originating” and “terminating” in FIG. 4 can be interchanged.

IMS network 450 can also be operably coupled to the proxy system 130 previously discussed for FIG. 1. In this representative embodiment, the survey system 130 can be accessed over a PSTN or VoIP channel of communication system 400 by common techniques such as described above.

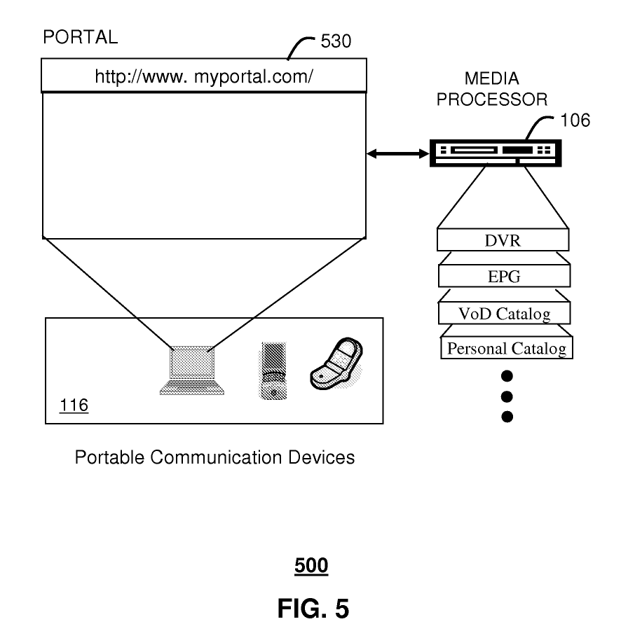

FIG. 5 depicts an exemplary embodiment of a portal 530. The portal 530 can be used for managing services of communication systems 100-400. The portal 530 can be accessed by a Uniform Resource Locator (URL) with a common Internet browser such as Microsoft's Internet Explorer using an Internet-capable communication device such as references 108, 116, or 210 of FIGS. 1-2. The portal 530 can be configured to access a media processor such as references 106, 204, 206, 316, and 324 of FIGS. 1-3 and services managed thereby such as a Digital Video Recorder (DVR), an Electronic Programming Guide (EPG), VOD catalog, a personal catalog stored in the STB (e.g., personal videos, pictures, audio recordings, etc.), and so on.

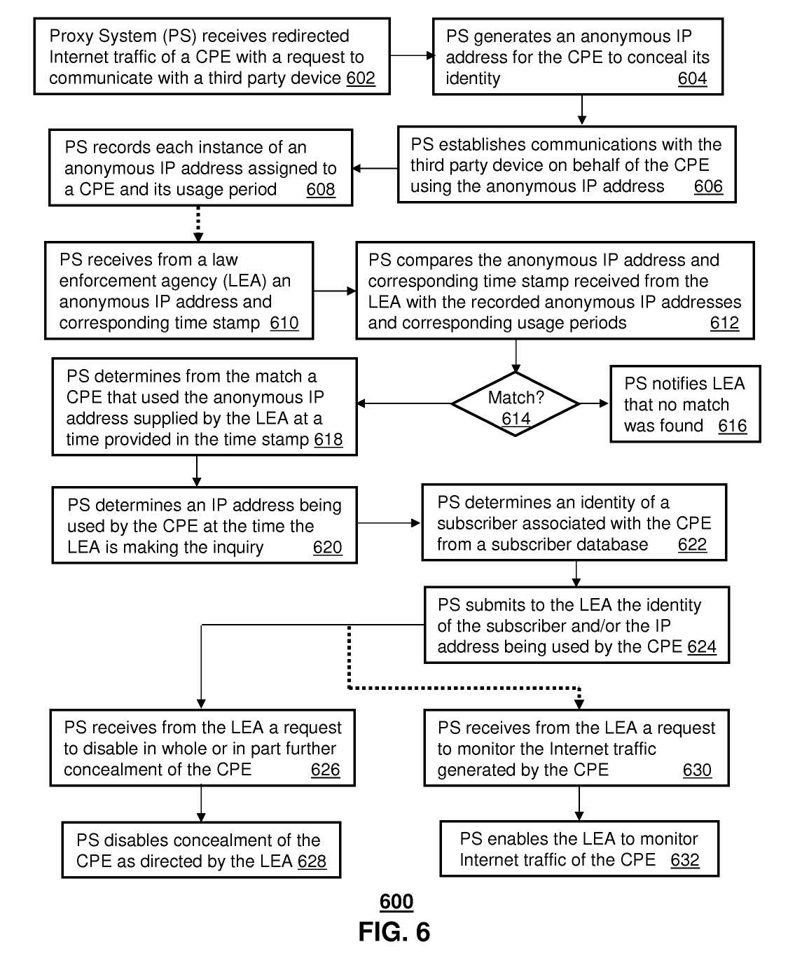

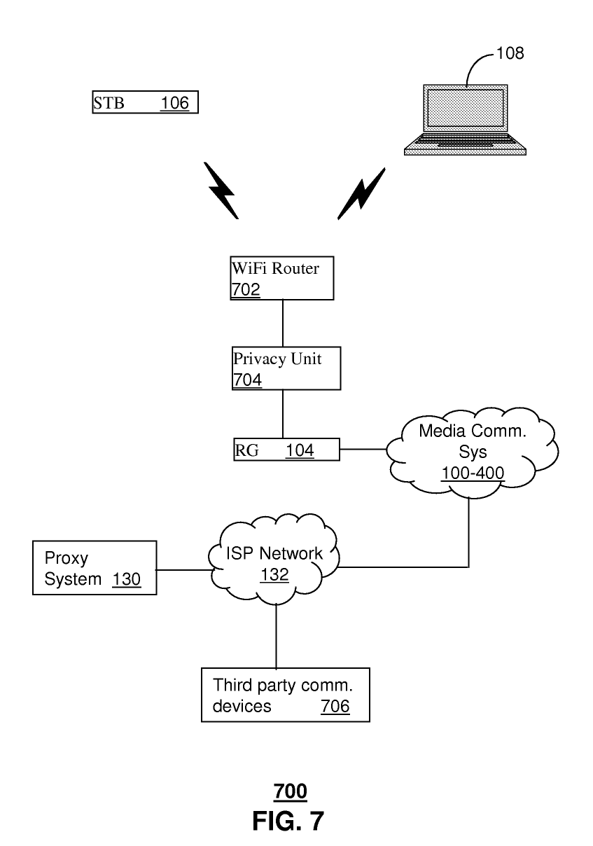

FIG. 6 depicts an exemplary method 600 operating in portions of communication systems 100-400. Method 600 begins with step 602 in which the proxy system 130 receives redirected Internet traffic from a CPE such as a modem or residential gateway. This step can be illustrated with the block diagram of FIG. 7 which shows a common computer 108 and/or STB 106 coupled to a WiFi router 702. The WiFi router 702 can be coupled to a privacy unit 704 which redirects Internet traffic generated by the STB 106 or computer 108 by way of a residential (RG) gateway 104 to the proxy system 130 which establishes concealed communications with a third party communication device 706 on a public network (such as the Internet) on behalf of the STB or computer. The RG 104 can be coupled to one of the media communication systems 100-400 previously described which provides the RG access to an ISP network 132. The ISP network 132 can be an integral part of the media communication system.

As noted earlier, the privacy unit 704 can be used to redirect Internet traffic generated by the STB 106 or the computing device 108 to the proxy system 130. The privacy unit 704 can perform this task using a secure link such as HTTPS/SSL. The privacy unit 130 can include headers in the redirected Internet traffic identifying the privacy unit (e.g., subscriber account number, authorization code(s), etc.) the third party communication device requested by the STB 106 or computer 108. The RG 104 redirects the Internet traffic as directed by the privacy unit 704 to the proxy system 130 by way of the media communication system and ISP network 132.

The proxy system 130 can determine by common methods the IP address assigned to the RG 104 by a domain name system (DNS) server which dynamically assigns IP addresses to network elements accessing an IP network. To conceal the IP address of the RG 104 from the third party communication device 706 requested by the STB 106 or computer 108, the proxy system 130 can be directed in step 604 to generate an anonymous IP address which substitutes the IP address assigned to the RG thereby concealing its identity. Once the anonymous IP address has been created, the proxy system 130 can be directed in step 606 to establish communications with the third party communication device 706 utilizing the anonymous IP address. If the third party communication device 706 attempts to read the IP address of the RG 104 it can only detect the anonymous IP address and therefore is unable to locate the RG 104 or the network elements coupled thereto (e.g., the privacy unit 704, WiFi Router 702, STB 106 or computing device 108).

The above steps can be repeated a number of times for the RG 104 thereby creating a history of anonymous IP addresses assigned to the RG at different points in time. The proxy system 130 can be directed in step 608 to record each instance of an anonymous IP address assigned to the RG 104 and its usage period such as date, time and duration (e.g., anonymous IP address XXX.XXX.XXX was assigned to RG 104 as directed by privacy unit 704 on Feb. 20, 2008, at 9:10 am for 1 hour and 22 minutes). Steps 602-608 can represent background steps which can be performed periodically between the privacy unit 704 and the proxy system 130.

A law enforcement agency (LEA) operating under the Communication Assistance for Law Enforcement Act (CALEA) can periodically monitor communications of individuals to protect the public from criminal activity on the Internet such as terrorism activity, identity theft, pedophiles targeting young children, phishing, pharming, and so on. When the LEA detects suspicious communications protected by an anonymous IP address produced by the proxy system 130, the LEA can record the anonymous IP address with a time stamp indicating when it was detected (date and time). The LEA can submit the anonymous IP address and time stamp to the proxy system 130 from which the anonymous IP address originated in step 610 to determine an identity of a source of the Internet traffic.

The proxy system 130 can compare in step 612 the information provided by the LEA to the recorded anonymous IP addresses and corresponding usage periods to determine which CPE utilized the anonymous IP address detected by the LEA at a time denoted by the time stamp provided by the LEA. If no matches are found, the proxy system 130 can be directed to inform the LEA in step 616 that no CPE matched the supplied anonymous IP address and corresponding time stamp. If a match is found, the proxy system 130 determines from the match which CPE and/or corresponding privacy unit 704 is associated with the anonymous IP address detected by the LEA. The proxy system 130 can also determine in step 620 which IP address is currently assigned to the identified CPE at the time the LEA makes the inquiry. The proxy system 130 can further determine in step 622 an identity of a subscriber of the privacy service provided by the proxy system from a subscriber database according to the identity of the CPE and/or the identity of the privacy unit 704.

In step 624, the proxy system 130 can inform the LEA of the identity of the subscriber and/or the IP address being used by the CPE at the present time. The LEA can in turn use this information to advance its investigations. The subscriber's identity supplied by the proxy system 130 can include a name of the subscriber, a residential or business address, and/or an identity of the ISP network 132 from which the CPE of the subscriber operates. Knowing the actual IP address being used by the CPE at the time the LEA submits an inquiry to the proxy system 130 in step 610, the LEA can utilize common tools to monitor the Internet traffic generated by the CPE without concealment and in some instances break through a firewall of the CPE an probe the communication devices operating in an intra-network behind the firewall of the CPE.

Responsive to its investigations, the LEA can submit a request to the proxy system 130 to disable in whole or in part further concealment of the CPE. This step can be performed with or without the knowledge of the subscriber of the privacy service as directed by the LEA. Partial disablement can represent disabling in step 628 concealment of the IP address assigned to the CPE by a DNS server for certain websites and not others, while total disablement can represent disabling concealment of the IP address of the CPE for all third party communications. In another illustrative embodiment the LEA can also request in step 630 for the proxy system 130 to enable the LEA in step 632 to monitor Internet traffic generated by the CPE. The proxy system 130 can accomplish this step by identifying a communication port from which the LEA can monitor traffic of the CPE without knowledge of the subscriber of the privacy service.

Upon reviewing the aforementioned embodiments, it would be evident to an artisan with ordinary skill in the art that said embodiments can be modified, reduced, or enhanced without departing from the scope and spirit of the claims described below. For example, the privacy unit 704 can represent an independent computing device as shown in FIG. 7 or a software client application operating within the WiFi router 702, the STB 106 or the computing device 108. Under this embodiment, the concealment process can apply to any IP-capable communication device including a portable communication device (e.g., cell phone, PDA, lap top computer, etc.) roaming for example in a cellular network such as described in FIG. 1.

Accordingly, method 600 can be adapted so that the proxy system 130 can be directed by the LEA to provide information relating to the roaming portable communication device including its assigned IP address, and/or an identity of the subscriber of the portable communication device. As before, the LEA can provide the proxy system 130 an anonymous IP address and time stamp detected by the LEA from Internet traffic generated by the proxy system on behalf of the roaming portable communication device. With this information, the proxy system 130 can identify the portable communication device, its current IP address, and/or an identification of its subscriber as described earlier for steps 610-624.

Other suitable modifications that can be applied to the present disclosure without departing from the scope of the claims below. Accordingly, the reader is directed to the claims section for a fuller understanding of the breadth and scope of the present disclosure.

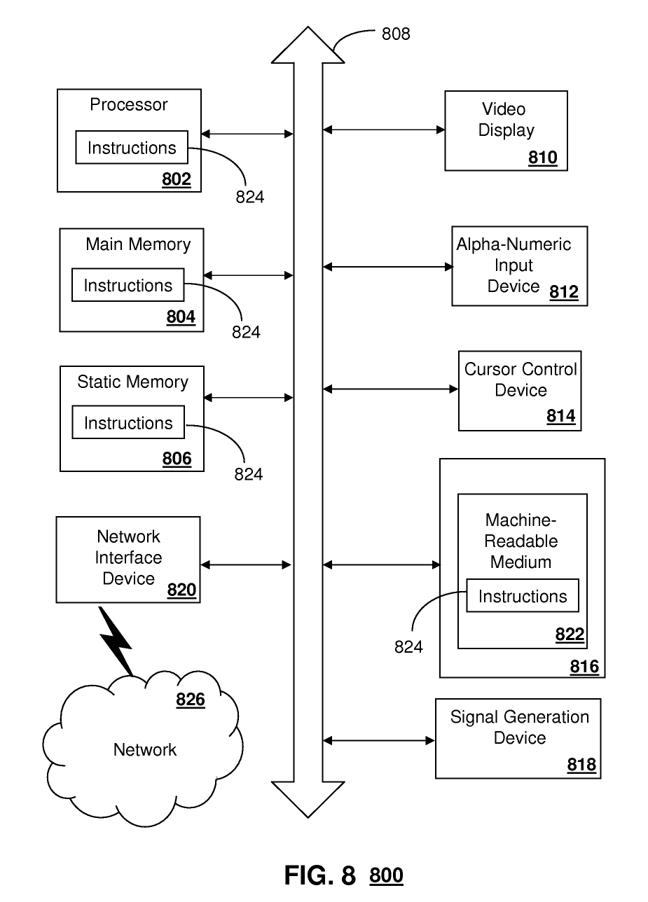

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
receiving from a law enforcement agency (LEA) an anonymous Internet Protocol (IP) address accompanied with a time stamp;
determining from the anonymous IP address and the time stamp at least one of an identity of the anonymous source and an IP address of customer premise equipment (CPE) used by the anonymous source to engage in Internet activities; and
submitting to the LEA at least one of the identity of the anonymous source and the IP address of the CPE used by the anonymous source.

2. The method of claim 1, wherein the LEA comprises an agency operating in conformance with the Communication Assistance for Law Enforcement Act (CALEA), and wherein the LEA detects the anonymous IP address from Internet activities of an anonymous source.

3. The method of claim 1, wherein the anonymous source is a subscriber of a privacy service that generates the anonymous IP address.

4. The method of claim 3, wherein the privacy service comprises a proxy system, wherein Internet traffic produced by the CPE is redirected to the proxy system utilizing the IP address assigned to the CPE by a network element of an Internet Service Provider (ISP) network from which the CPE operates, and wherein the proxy system creates the anonymous IP address to conceal the IP address of the CPE when the CPE communicates with third party devices.

5. The method of claim 1, wherein identity of the anonymous source comprises at least one of a name of the anonymous source, an address of the anonymous source, and an identity of an ISP network from which the CPE operates.

6. The method of claim 1, wherein the LEA utilizes the IP address of the CPE to monitor the CPE.

7. The method of claim 1, comprising enabling the LEA to monitor Internet traffic of the CPE responsive to receiving a request from the LEA.

8. The method of claim 1, comprising disabling the use of the anonymous IP address by the CPE responsive to receiving a request from the LEA.

9. The method of claim 1, comprising disabling subsequent generation of anonymous IP addresses for the CPE responsive to receiving a request from the LEA.

10. The method of claim 1, comprising selectively disabling generation of anonymous IP addresses for the CPE for establishing communications between the CPE and one or more websites identified in a request supplied by the LEA.

11. The method of claim 1, wherein the time stamp comprises at least one of a date, and time of day, wherein the CPE corresponds to a residential gateway, wherein the residential gateway operates in a media communication system, and wherein the media communication system corresponds to at least one of an ISP network, an Internet Protocol Television communication system, a cable TV communication system, a satellite TV communication system, a Public Switched Telephone Network, a Voice over IP (VoIP) communication system, and a IP Multimedia Subsystem combining the PSTN and VoIP communication systems.

12. The method of claim 1, comprising:
recording anonymous IP addresses used by the CPE and corresponding usage periods; and
comparing the anonymous IP address and time stamp supplied by the LEA to the recorded anonymous IP addresses and corresponding usage periods to identify the CPE and the IP address used by the CPE at a time when the anonymous IP address and corresponding time stamp is received from the LEA.

13. The method of claim 12, comprising determining the anonymous source from a subscriber database according to the identified CPE.

14. A computer-readable storage medium, comprising computer instructions for determining from an anonymous Internet Protocol (IP) address and a time stamp supplied by a law enforcement agency (LEA) at least one of an identity of an anonymous source and an IP address of customer premise equipment (CPE) used by the anonymous source to engage in concealed Internet activities.

15. The storage medium of claim 14, comprising computer instructions for submitting to the LEA the identity of the anonymous source and/or the IP address of the CPE responsive to receiving from the LEA an anonymous IP address and a time stamp indicating when the anonymous IP address was detected in use by the LEA.

16. The storage medium of claim 15, comprising computer instructions for:
recording anonymous IP addresses used by the CPE and corresponding usage periods; and
comparing the anonymous IP address and time stamp supplied by the LEA to the recorded anonymous IP addresses and corresponding usage periods to identify the CPE and the IP address used by the CPE at a time when the anonymous IP address and corresponding time stamp is received from the LEA.

17. The storage medium of claim 16, comprising computer instructions for determining the anonymous source from a subscriber database according to the identified CPE.

18. The storage medium of claim 14, wherein the computer-readable storage medium operates in a proxy system that conceals the identity of the CPE from third party devices.

19. The storage medium of claim 14, comprising computer instructions for enabling the LEA to monitor packet traffic of the CPE responsive to receiving a request from the LEA.

20. The storage medium of claim 14, comprising computer instructions for disabling subsequent generation of anonymous IP addresses for the CPE responsive to receiving a request from the LEA.

21. A proxy system, comprising a controller to submit to a law enforcement agency (LEA) an identity of a source that conceals its identity with one or more anonymous Internet Protocol (IP) addresses.

22. The proxy system of claim 21, wherein the identity comprises at least one of an IP address of a customer premise equipment (CPE) concealed with an anonymous IP address by the proxy system and a subscriber of services provided by the proxy system, and wherein the controller is adapted to conceal the identity of the source with assistance from a privacy unit that redirects Internet traffic of the CPE to the proxy system.

23. The proxy system of claim 21, wherein the controller is adapted to receive from the LEA an anonymous IP address and a time stamp indicating when the anonymous IP address was detected in use by the LEA to determine the identity of the source.

24. The proxy system of claim 23, wherein the controller is adapted to:
record the one or more anonymous IP addresses used by a CPE of the source and corresponding one or more usage periods; and
compare the anonymous IP address and time stamp supplied by the LEA to the recorded anonymous IP addresses and corresponding usage periods to identify the CPE.

25. The proxy system of claim 24, wherein the controller is adapted to identify a subscriber associated with the CPE from a subscriber database according to the identified CPE.
